(19) United States
(12) Patent Application Publication
(10) Pub. No.: US 2024/0267922 A1
(43) Pub. Date: Aug. 8, 2024

(54) METHOD AND APPARATUS FOR PHYSICAL UPLINK CONTROL CHANNEL (PUCCH) TRANSMISSION

(71) Applicant: Lenovo (Beijing) Limited, Beijing (CN)

(72) Inventors: Wei Ling, Beijing (CN); Chenxi Zhu, Fairfax, VA (US); Bingchao Liu, Beijing (CN); Yi Zhang, Beijing (CN); Lingling Xiao, Beijing (CN)

(73) Assignee: Lenovo (Beijing) Limited, Beijing (CN)

(21) Appl. No.: 18/564,741

(22) PCT Filed: Jul. 15, 2021
(86) PCT No.: PCT/CN2021/106470

§ 371 Date: Nov. 28, 2023

(51) Int. Cl. H04W 72/21; H04B 7/06

(52) U.S. Cl. CPC H04W 72/21; H04B 7/0617

(57) ABSTRACT

Embodiments of the present application are related to a method and apparatus for physical uplink control channel (PUCCH) transmission. An exemplary method of the present application includes: receiving information for determining a plurality of beams; receiving a beam indication indicating at least one beam of the plurality of beams to be used for transmission of a PUCCH resource; and transmitting the PUCCH resource according to the beam indication.

### TECHNICAL FIELD

Embodiments of the present application generally relate to wireless communication technology, especially to a method and an apparatus for physical uplink control channel (PUCCH) transmission.

### BACKGROUND

Regarding enhancements on multiple-input multiple-output (MIMO) for new radio (NR), a work item description (WID) approved in NR R17 includes enhancement on multi-beam operation, mainly targeting frequency range (FR)2 while also applicable to FR1. Wherein, a research topic is to identify and specify features to facilitate more efficient (lower latency and overhead) downlink/uplink (DL/UL) beam management to support higher intra-band and L1/L2-centric inter-cell mobility and/or a larger number of configured transmission configuration indication (TCI) states, including common beam for data and control transmission/reception for DL and UL, especially for intra-band carrier aggregation (CA).

In addition, it has been agreed that downlink control information (DCI) format 1_1 and DCI format 1_2 can be used for DL and UL joint common beam indication, and it has been proposed that DCI format 1_1 and DCI format 1_2 can be used for UL only common beam indication in RAN1 #103e. Moreover, more than one joint or UL common beams indicated by DCI in a physical downlink control channel (PDCCH) is also under discussion especially for the case of multiple transmit-receive points (TRP)s. For a PUCCH resource (or a PUCCH transmission, or a PUCCH transmission occasion) in a scenario of multiple TRPs, e.g., two TRPs, in the case that the PUCCH resource is configured with multiple repetitions while a user equipment (UE) is not applicable to transmit UL resources with multiple beams simultaneously, the PUCCH resource can be transmitted to any of the two TRPs or both of the two TRPs in a time division multiplexing (TDM) manner. However, how to indicate which beam(s) of the more than one beam is used to transmit the PUCCH resource has not been solved yet.

Therefore, the industry still needs to improve technical solutions for PUCCH transmission, especially for PUCCH transmission in the scenario of multiple TRPs.

### SUMMARY OF THE APPLICATION

One objective of the embodiments of the present application is to provide a technical solution for PUCCH transmission, e.g., beam indication for PUCCH transmission.

According to an embodiment of the present application, a method may include: receiving information for determining a plurality of beams; receiving a beam indication indicating at least one beam of the plurality of beams to be used for transmission of a PUCCH resource; and transmitting the PUCCH resource according to the beam indication.

According to another embodiment of the present application, a method may include: transmitting information for determining a plurality of beams; transmitting a beam indication indicating at least one beam of the plurality of beams to be used for transmission of a PUCCH resource; and receiving the PUCCH resource according to the beam indication.

In some embodiments of the present application, the beam indication is received or transmitted in configuration information of the PUCCH resource.

In some other embodiments of the present application, the beam indication is received or transmitted in configuration information of a PUCCH resource group at least including the PUCCH resource.

In some yet other embodiments of the present application, the beam indication is received or transmitted in a medium access control (MAC) control element (CE) associated with the PUCCH resource, and the MC CE indicates an identity of a serving cell for which the MAC CE is applied and an identity of a bandwidth part (BWP) for which the MAC CE is applied. The MAC CE may also indicate an identity of the PUCCH resource or an identity of another PUCCH resource in a PUCCH resource group at least including the PUCCH resource according to some embodiments of the present application. For the PUCCH resource group, the MAC CE includes an identity of only one PUCCH resource of the PUCCH resource group. The MAC CE may also indicate an identity of a PUCCH resource group at least including the PUCCH resource according to some other embodiments of the present application.

Some embodiments of the present application also provide an apparatus, including: at least one non-transitory computer-readable medium having computer executable instructions stored therein, at least one receiving circuitry; at least one transmitting circuitry; and at least one processor coupled to the at least one non-transitory computer-readable medium, the at least one receiving circuitry and the at least one transmitting circuitry. The computer executable instructions are programmed to implement a method according to an embodiment of the present application with the at least one receiving circuitry, the at least one transmitting circuitry and the at least one processor.

Embodiments of the present application provide a technical solution for PUCCH transmission, especially for beam indication for PUCCH transmission in case of multiple beams being configured or predefined, and thus can facilitate and improve the implementation of 5G NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to an embodiment of the present application;

FIG. 2 is a flow chart illustrating a method for PUCCH transmission according to some embodiments of the present application;

FIG. 3 illustrates an exemplary MAC CE design for indicating the beam indication according to some embodiments of the present application;

FIG. 4 illustrates an exemplary MAC CE design for indicating the beam indication according to some other embodiments of the present application; and

FIG. 5 illustrates a block diagram of an apparatus for PUCCH transmission according to some embodiments of the present application.

### DETAILED DESCRIPTION

The detailed description of the appended drawings is intended as a description of preferred embodiments of the present application, and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE) Release 8 and so on. It is contemplated that along with the developments of network architectures and new service scenarios, all embodiments in the present application are also applicable to similar technical problems. Moreover, the terminologies recited in the present application may change, which should not affect the principle of the present application.

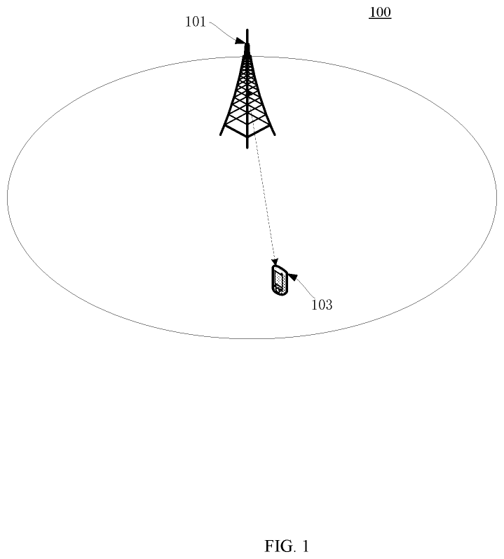

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The BS 101 may be distributed over a geographic region, and generally be a part of a radio access network (RAN) that may include one or more controllers communicably coupled to one or more corresponding BSs 101. In some embodiments of the present application, the BS 101 may also be referred to as an access point, an access terminal, a base, a macro cell, a Node-B, an evolved Node B (eNB), a TRP, a gNB, a Home Node-B, a relay node, a device, or described using other terminology used in the art.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art. Different UEs 103 may be with the same device type or different device types.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

According to NR R17, multiple beams, e.g., two beams can be indicated or configured for uplink transmission with repetition, e.g., PUCCH transmission with repetition, wherein each beam is associated with at least one repetition according a configured beam mapping pattern. Herein (throughout the specification), the terminology “beam” can be represented by “TCI state” or “spatial relation information” etc. However, a UE may not have the capability to transmit a UL transmission with two beams simultaneously considering the power limitation of UEs. Meanwhile, during multi-TRP transmissions, a MAC CE activates two beams or power control parameter sets for a PUCCH transmission with repetition transmitted to multiple TRPs. For a PUCCH transmission activated by a MAC CE with only one beam, it is transmitted to a single TRP. Therefore, the beam(s) activated by a MAC CE for a PUCCH resource can indicate to which TRP the PUCCH resource will be transmitted.

However, there is no more MAC CE for a specific PUCCH resource to indicate to which TRP the PUCCH resource is transmitted in a common beam mode. For common beam(s), R17 agreed that joint common beam(s) or UL common beam(s) is indicated by a DCI (i.e., DCI in a PDCCH) for all PUSCH transmissions and all or subset of PUCCH resources, wherein a PUCCH resource may be a PUCCH resource with multiple repetitions or PUCCH resource without repetition.

Thus, when more than one joint or UL common beam is indicated for PUCCH transmission, which may be a PUCCH transmission with repetition or PUCCH transmission without repetition, how to indicate (or determine) the common beam(s) for a specific PUCCH resource should be solved. When more than one default beam is indicated or predefined for PUCCH transmission, a similar problem also exists.

At least for solving the above technical problems, embodiments of the present application provide a technical solution for PUCCH transmission, especially for indication (or determination) of common or default beam(s) for PUCCH transmission.

According to some embodiments of the present application, a plurality of beams are indicated or determined according to a predefined rule to a UE for PUCCH transmission, e.g., considering a scenario of multi-TRP or multi-panel. In some embodiments of the present application, the plurality of beams are more than one joint or UL common beam. In some other embodiments of the present application, the plurality of beams are more than one default beam. The network side, e.g., a gNB may indicate the plurality of joint or UL common beams or the plurality of default beams in an explicit manner or implicit manner. The remote side, e.g., a UE will determine the plurality of beams from the received information.

A PUCCH transmission can also be referred to as a PUCCH resource. In the case that the number of repetition is defined to be larger than one, the PUCCH transmission can be a PUCCH resource without repetition or a PUCCH resource with repetition. A PUCCH transmission occasion is a repetition of a PUCCH transmission with repetition, or a PUCCH transmission without repetition. While, in the case that the number of repetition is defined to be equal to or larger than one, each PUCCH transmission can be called as a PUCCH resource with repetition, including a PUCCH resource that is only transmitted once. In such a case, a PUCCH transmission occasion is a repetition of a PUCCH transmission. Herein, if no otherwise specified, the first expression will be adopted, that is, PUCCH resource (or PUCCH transmission) with repetition means the number of repetition is larger than one. In any of the above cases, the repetition number of a PUCCH transmission can be RRC configured per PUCCH format.

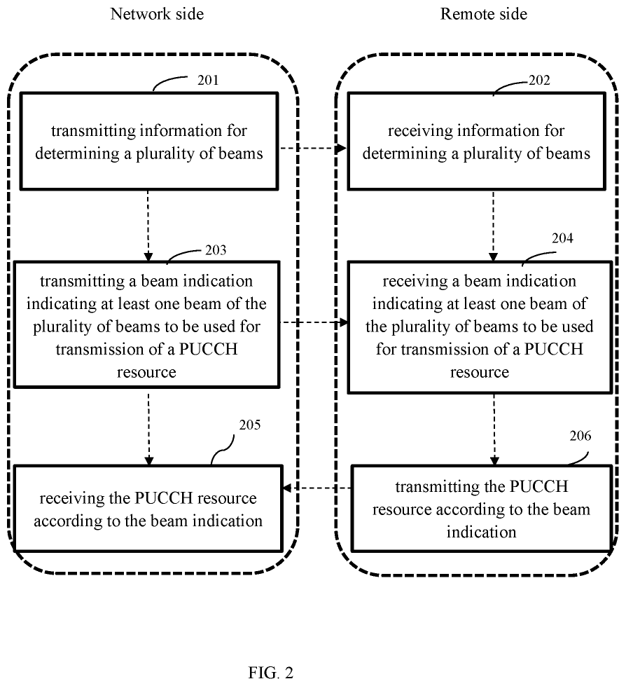

FIG. 2 illustrates a flow chart of a method for PUCCH transmission according to some embodiments of the present application. Although the method is illustrated in a system level by a UE in a remote side (or UE side) and a BS in a network side (or BS side), persons skilled in the art can understand that the method implemented in the remote side and that implemented in the network side can be separately implemented and incorporated by other apparatus with similar functions. In addition, no transmission or reception failure is considered in the illustrated embodiments of the present application.

As shown in FIG. 2, in step 201, the network side, e.g., a gNB will transmit information for determining a plurality of beams to the remote side, e.g., a UE. In step 202, the information for determining a plurality of beams will be received in the remote side, e.g., by the UE. In some embodiments of the present application, the information for determining a plurality of beams is DCI in a PDCCH, which indicates a plurality of TCI states on behalf of a plurality of beams, e.g., a plurality of joint or UL common beams. The UE can determine the plurality of beams from the DCI indicating the plurality of TCI states.

However, as stated above, the UE does not have the capability to transmit more than one beam simultaneously. That is, only one of the plurality of beams can be used to transmit a PUCCH transmission occasion. Thus, for a PUCCH resource to be transmitted, the UE needs to know which beam(s) should be used.

According to some embodiments of the present application, a beam indication is introduced to specifically indicate with which beam(s) a PUCCH resource is transmitted. As shown in FIG. 2, in step 203, the network side, e.g., the gNB will transmit a beam indication indicating at least one beam of the plurality of beams to be used for transmission of a PUCCH resource. Accordingly, in step 204, the remote side, e.g., the UE will receive the beam indication.

For example, according to some embodiments of the present application, the beam indication will be transmitted from the gNB and received by the UE in the configuration information of the PUCCH resource, which may be configured by a RRC signaling. In some other embodiments of the present application, the beam indication will be transmitted from the gNB and received by the UE in the configuration information of a PUCCH resource group, which may be configured by a RRC signaling, wherein the PUCCH resource group at least includes the PUCCH resource to be transmitted.

According to some embodiments of the present application, the beam indication will be transmitted from the gNB and received by the UE in a MAC CE associated with the PUCCH resource, wherein the MC CE indicates the identity of a serving cell for which the MAC CE is applied and the identity of a BWP for which the MAC CE is applied. The MAC CE may also indicate the identity of a PUCCH resource or the identity of a PUCCH resource group. For example, in some embodiments of the present application, the MAC CE may indicate the identity of the PUCCH resource or the identity of another PUCCH resource in the PUCCH resource group at least including the PUCCH resource. In such a case, for the PUCCH resource group, the MAC CE includes the identity of only one PUCCH resource of the PUCCH resource group. That is, except for the only one indicated PUCCH resource, no other PUCCH resource(s) within the same PUCCH group is indicated in the MAC CE, and this MAC CE will be applied to all the PUCCH resources in the PUCCH group. In some other embodiments of the present application, the MAC CE may indicate the identity of the PUCCH resource group at least including the PUCCH resource. Similarly, this MAC CE will be applied to all the PUCCH resources in the PUCCH group.

The beam indication can be defined to have a plurality of states. Except for the reserved state(s) (if any), each state indicates which beam(s) will be used for transmitting a PUCCH resource. For example, in the case that there are two beams, e.g., two joint or UL common beams or two default beams determined from the received information by the UE, at least three states can be defined for the beam indication to indicate one or more beams for transmission of a PUCCH resource. In some embodiments of the present application, the first state indicates that a PUCCH resource is transmitted with the first beam of the two beams; the second state indicates that a PUCCH resource is transmitted with the second beam of the two beams; and the third state is for a PUCCH resource with repetition, which indicates that a PUCCH resource is transmitted with both of the two beams in the TDM manner, wherein the first repetition of the PUCCH resource is transmitted with the first beam of the two beams. In some embodiments of the present application, the third state for a PUCCH resource with repetition may indicates that a PUCCH resource is transmitted with both of the two beams in the TDM manner, wherein the first repetition of the PUCCH resource is transmitted with the second beam of the two beams. However, in some other embodiments of the present application, four states of the beam indication can be defined, and the later exemplary third state, i.e., indicating that a PUCCH resource is transmitted with both of the two beams in the TDM manner, wherein the first repetition of the PUCCH resource is transmitted with the second beam of the two beams, is defined as the fourth state.

According to some embodiments of the present application, two bits can be used to indicate a state of the beam indication, for example, “00” can be used to indicate the first state, “01” can be used to indicate the second state, “10” can be used to indicate the third state, and “11” can be used to indicate the fourth state if any or can be reserved if only three states are substantially defined.

Persons skilled in the art should understand that the above exemplary embodiments for defining and indicating the states of a beam indication are only for illustrating the concept and principle of the beam indication, which should not be used to limit the scope of the present application. For example, the substantial definition of the first state may change with the second or third state or fourth state, indicating that a PUCCH resource is transmitted with the second beam of the two beams; or indicating a PUCCH resource is transmitted with both of the two beams in the TDM manner, wherein the first repetition of the PUCCH resource is transmitted with the first beam of the two beams; or indicating a PUCCH resource is transmitted with both of the two beams in the TDM manner, wherein the first repetition of the PUCCH resource is transmitted with the first beam of the two beams.

In addition, persons skilled in the art should understand that the present application can also be applied to any scenario wherein multiple beams are configured or predefined but only part of them can be used for transmission, and the beam indication can be specifically designed in view of the number of the multiple beams and the beam(s) to be used for transmission.

After receiving the beam indication, the UE will determine the beam(s) used for the transmission of a PUCCH resource. As shown in FIG. 2, the UE will transmit the PUCCH resource according to the beam indication in step 206. Accordingly, the network side, e.g., the gNB will receive the PUCCH resource according to the beam indication in step 205. In the case that the PUCCH resource is a PUCCH resource with repetition, wherein the number of repetition is larger than one, a beam mapping pattern, e.g., a cyclical mapping pattern or a sequential mapping pattern as agreed by 3GPP, will also be indicated to the remote side. The UE will transmit the PUCCH resource with repetition according to the beam indication and the beam mapping pattern. Accordingly, the gNB will receive the PUCCH resource with repetition according to the beam indication and the beam mapping pattern.

For example, the network side may configure two joint or UL common beams, e.g., beam #1 and beam #2 by transmitting DCI in a PDCCH indicating two TCI states, e.g., TCI state #1 on behalf of beams #1, and TCI state #2 on behalf of beam #2. For a PUCCH resource with repetition to be transmitted, a beam indication indicates that both the two beams will be used to transmit the PUCCH resource with repetition, wherein the first beam will be used to transmit the first repetition of the PUCCH resource. In addition, a beam mapping pattern will be received, so that each repetition is associated with a corresponding beam of the two beams based on the beam mapping pattern. The beam mapping pattern can be any beam mapping pattern, e.g., a cyclical mapping pattern, or a sequential mapping pattern. For example, when the cyclical mapping pattern is enabled, the first and second beams (or TCI states) are applied to the first and second transmit units, respectively, and the same mapping pattern continues to the remaining transmit units. Accordingly, the cyclical mapping pattern might be #1 #2 #1 #2 #1 #2 #1 #2 . . . . When the sequential mapping pattern is enabled, the first beam is applied to the first and second transmit units, and the second beam is applied to the third and fourth transmit units, and the same beam mapping pattern continues to the remaining transmit units. Accordingly, the sequential mapping pattern might be #1 #1 #2 #2 #1 #1 #2 #2 . . . .

Although the above embodiments only illustrate two common beams (TCI states), persons skilled in the art should well know the technical solutions based on other common or default beam numbers under the above disclosure and teaching.

The beam indication according to embodiments of the present application can be implemented in various manners, e.g., via the configuration information of the PUCCH resource or the configuration information of the PUCCH resource group at least including the PUCCH resource, or via a MAC CE as briefly stated above. More details on two exemplary solutions of the present application will be illustrated in the following text to help understand the technical solutions of the present application.

### Solution 1: RRC Signaling

According to some embodiments of the present application, in Solution 1, the beam indication may be configured per PUCCH resource by a RRC signalling, or may be configured per PUCCH resource group by a RRC signaling, each PUCCH resource group including at least one PUCCH resource. When the beam indication is configured per PUCCH resource group by a RRC signaling, even if multiple PUCCH groups are configured by the RRC signaling, each PUCCH resource is included in only one of the multiple PUCCH groups. That is, a PUCCH resource cannot be included in more than PUCCH group configured by the RRC signaling.

When the beam indication is configured per PUCCH resource by a RRC signalling, the beam indication is included in the configuration information of a PUCCH resource. An exemplary of the RRC signaling configuring the PUCCH resource in view of two common beams or default beams is shown as follows:

```
PUCCH-Resource :: = SEQUENCE {
  pucch-ResourceId PUCCH-ResourceId,
  startingPRB PRB-Id,
  intraSlotFrequencyHopping ENUMERATED { enabled } OPTIONAL, -- Need R
  secondHopPRB PRB-Id OPTIONAL, -- Need R
  format CHOICE {
    format0 PUCCH-format0,
    format1 PUCCH-format1,
    format2 PUCCH-format2,
    format3 PUCCH-format3,
    format4 PUCCH-format4
    }
  beam indication CHOICE {00,01,10,11} OPTIONAL,
}
```

It can be seen that the beam indication in the RRC signalling has four optional states, respectively being indicated by: 00, 01, 10, 11. Each state can be defined as stated above. The network side can indicate a proper state of the beam indication to the UE in view of a PUCCH resource to be transmitted. For example, for a PUCCH resource without repetition, the beam indication may indicate “00,” which means the first beam of the two beams will be used to transmit the PUCCH resource. In another example, for a PUCCH resource with repetition, wherein the number of repetition is larger than one, the beam indication may indicate “10,” which means both two beams will be used to transmit the PUCCH resource while the first beam of the two beams will be used to transmit the first repetition of the PUCCH resource. In addition, persons skilled in the art should understand that the segment “beam indication” is only named for illustration, it may be expressed in other wording, which should not be used to limit the scope of the present application. Hereafter, the same.

When the beam indication is configured per PUCCH resource group by a RRC signalling, the beam indication is included in the configuration information of a PUCCH resource group at least including the PUCCH resource to be transmitted. The beam indication will be applied to all PUCCH resource(s) in the PUCCH resource group. An exemplary of the RRC signaling configuring the PUCCH resource group in view of two common beams or default beams is shown as follows:

```
PUCCH-ResourceGroup-r16 ::= SEQUENCE {
  pucch-ResourceGroupId-r16 PUCCH-ResourceGroupld-r16,
  resourcePerGroupList-r16 SEQUENCE (SIZE
  (1..maxNrofPUCCH-ResourcesPerGroup-r16)) OF PUCCH-ResourceId
  beam indication CHOICE {00,01,10,11} OPTIONAL,
}
```

It can be seen that the beam indication in the RRC signalling has four optional states, respectively being indicated by: 00, 01, 10, 11. Each state can be defined as stated above. The network side can indicate a proper state of the beam indication to the UE in view of a PUCCH resource to be transmitted of the PUCCH resource group. For example, for PUCCH resources in a PUCCH resource group, the beam indication may indicate “01,” which means the second beam of the two beams will be used to transmit the PUCCH resources in the PUCCH resource group. In another example, for PUCCH resources in another PUCCH resource group, the beam indication may indicate “11,” which means both two beams will be used to transmit the PUCCH resources in the PUCCH resource group while the second beam of the two beams will be used to transmit the first repetitions of the PUCCH resources.

### Solution 2: MAC CE

According to some embodiments of the present application, in Solution 2, the beam indication is indicated by a MAC CE associated with a PUCCH resource to be transmitted. The MAC CE may indicate the identity of a serving cell for which the MAC CE is applied, and an identity of a BWP for which the MAC CE is applied. The MAC CE may also indicate the identity of the PUCCH resource to be transmitted or the identity of another PUCCH resource in a PUCCH resource group at least including the PUCCH resource. Whatever, for a specific PUCCH resource group, the MAC CE includes the identity of only one PUCCH resource of the PUCCH resource group. In the other words, when a PUCCH resource indicated in the MAC CE is included in a PUCCH group configured by a RRC signaling, the beam indication in the MAC CE is applied for all PUCCH resource(s) in the PUCCH group.

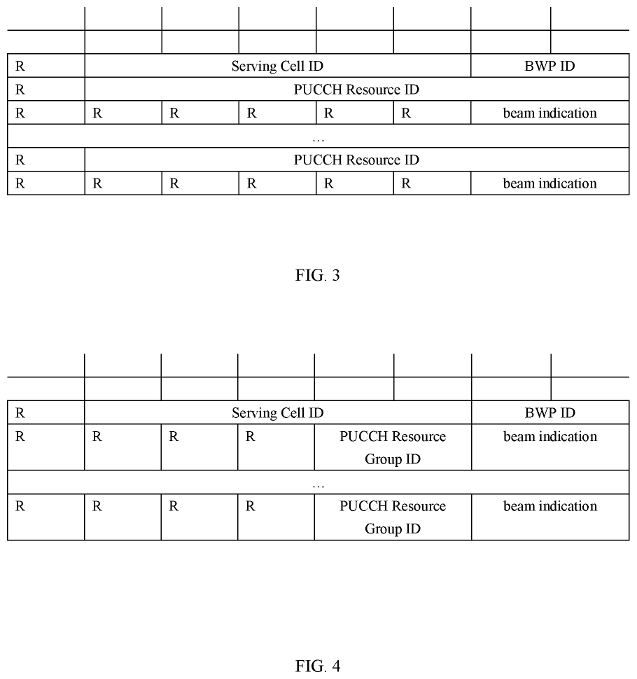

FIG. 3 illustrates an exemplary MAC CE design for indicating the beam indication according to some embodiments of the present application.

As shown in FIG. 3, the beam indication is in the exemplary MAC CE associated with the PUCCH resource to be transmitted, which may indicate the identity of the PUCCH resource to be transmitted or the identity of another PUCCH resource in the same PUCCH group as the PUCCH resource to be transmitted. The MAC CE may include one or more beam indications for different PUCCH resources. Specifically, the MAC CE has a variable size with the following fields:
Serving Cell ID: This field indicates the identity of the serving cell for which the MAC CE applies, and the length of the field is 5 bits;
BWP ID: This field indicates a UL BWP for which the MAC CE applies as the codepoint of the DCI bandwidth part indicator field as specified in TS 38.212, and the length of the BWP ID field is 2 bits;
PUCCH Resource ID: This field contains an identifier of the PUCCH resource ID identified by PUCCH-ResourceId as specified in TS 38.331; the length of the field is 7 bits; if the indicated PUCCH resource is configured as part of a PUCCH group as specified in TS 38.331, no other PUCCH resources within the same PUCCH group are indicated in the MAC CE; and this MAC CE applies to all the PUCCH resources in the PUCCH group;
beam indication: This field contains an indication of single or multiple beams for the PUCCH resource ID, and the length of the field is 2 bits;
R: Reserved bit, set to 0.

In addition, persons skilled in the art should understand that the field “beam indication” is only named for illustration, it may be expressed in other wording, which should not be used to limit the scope of the present application. Hereafter, the same.

According to some other embodiments of the present application, in Solution 2, the beam indication is indicated by a MAC CE for its associated PUCCH resource group configured in a RRC signaling, and the beam indication is applied for all PUCCH resources in the associated PUCCH resource group. The MAC CE may indicate the identity of a serving cell for which the MAC CE is applied, an identity of a BWP for which the MAC CE is applied, and the identity of a PUCCH resource group at least including the PUCCH resource to be transmitted.

FIG. 4 illustrates an exemplary MAC CE design for indicating the beam indication according to some other embodiments of the present application.

As shown in FIG. 4, the beam indication is in the exemplary MAC CE associated with the PUCCH resource to be transmitted, which may indicate the identity of the PUCCH resource group at least including the PUCCH resource to be transmitted. The MAC CE may include one or more beam indications for different PUCCH resource groups. Specifically, the MAC CE has a variable size with the following fields:
Serving Cell ID: This field indicates the identity of the serving cell for which the MAC CE applies, and the length of the field is 5 bits;
BWP ID: This field indicates a UL BWP for which the MAC CE applies as the codepoint of the DCI bandwidth part indicator field as specified in TS 38.212, and the length of the BWP ID field is 2 bits;
PUCCH Resource Group ID: This field contains an identifier of the PUCCH resource group ID identified by PUCCH-ResourceGroupId as specified in TS 38.331, and the length of the field is 2 bits, and this MAC CE applies to all the PUCCH resources in a PUCCH group with the PUCCH-ResourceGroupId;
beam indication: This field contains an indication of single or multiple beam for the PUCCH resource ID, and the length of the field is 2 bits;
R: Reserved bit, set to 0.

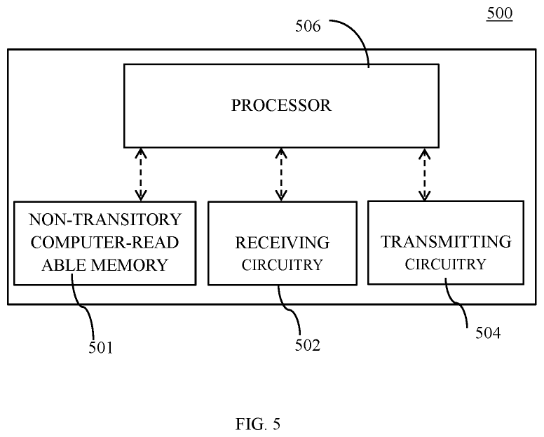

In addition, embodiments of the present application also propose an apparatus for PUCCH transmission. For example, FIG. 5 illustrates a block diagram of an apparatus 500 for PUCCH transmission according to some embodiments of the present application.

As shown in FIG. 5, the apparatus 500 may include at least one non-transitory computer-readable medium 501, at least one receiving circuitry 502, at least one transmitting circuitry 504, and at least one processor 506 coupled to the non-transitory computer-readable medium 501, the receiving circuitry 502 and the transmitting circuitry 504. The apparatus 500 may be a network side apparatus (e.g., a BS) configured to perform a method illustrated in FIG. 2 and the like, or a remote unit (e.g., a UE) configured to perform a method illustrated in FIG. 5 or the like.

Although in this figure, elements such as the at least one processor 506, transmitting circuitry 504, and receiving circuitry 502 are described in the singular, the plural is contemplated unless a limitation to the singular is explicitly stated. In some embodiments of the present application, the receiving circuitry 502 and the transmitting circuitry 504 can be combined into a single device, such as a transceiver. In certain embodiments of the present application, the apparatus 500 may further include an input device, a memory, and/or other components.

For example, in some embodiments of the present application, the non-transitory computer-readable medium 501 may have stored thereon computer-executable instructions to cause a processor to implement the method with respect to the UE as described above. For example, the computer-executable instructions, when executed, cause the processor 506 interacting with receiving circuitry 502 and transmitting circuitry 504, so as to perform the steps with respect to the UE depicted in FIG. 2.

In some embodiments of the present application, the non-transitory computer-readable medium 501 may have stored thereon computer-executable instructions to cause a processor to implement the method with respect to the BS as described above. For example, the computer-executable instructions, when executed, cause the processor 506 interacting with receiving circuitry 502 and transmitting circuitry 504, so as to perform the steps with respect to the BS depicted in FIG. 2.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A method performed by a user equipment (UE), the method comprising:
receiving information for determining a plurality of beams;
receiving a beam indication indicating at least one beam of the plurality of beams to be used for transmission of a physical uplink control channel (PUCCH) resource; and
transmitting the PUCCH resource according to the beam indication.

2. The method of claim 1, wherein the beam indication is received in configuration information of the PUCCH resource.

3. The method of claim 1, wherein the beam indication is received in configuration information of a PUCCH resource group at least comprising the PUCCH resource.

4. The method of claim 1, wherein the beam indication is received in a medium access control (MAC) control element (CE) associated with the PUCCH resource, and the MAC CE indicates an identity of a serving cell for which the MAC CE is applied and an identity of a bandwidth part (BWP) for which the MAC CE is applied.

5. The method of claim 4, wherein the MAC CE indicates an identity of the PUCCH resource or an identity of another PUCCH resource in a PUCCH resource group at least comprising the PUCCH resource.

6. The method of claim 5, wherein for the PUCCH resource group, the MAC CE comprises an identity of only one PUCCH resource of the PUCCH resource group.

7. The method of claim 1, wherein the plurality of beams is a first beam and a second beam, and the beam indication indicates at least one of the first beam or the second beam for the PUCCH resource.

8. A base station (BS) for wireless communication, comprising:
at least one memory; and
at least one processor coupled with the at least one memory and configured to cause the BS to:
transmit information for determining a plurality of beams;
transmit a beam indication indicating at least one beam of the plurality of beams to be used for transmission of a physical uplink control channel (PUCCH) resource; and
receive the PUCCH resource according to the beam indication.

9. The BS of claim 8, wherein the beam indication is transmitted in at least one of configuration information of the PUCCH resource, or configuration information of a PUCCH resource group at least comprising the PUCCH resource.

10. (canceled)

11. The BS of claim 8, wherein the beam indication is transmitted in a medium access control (MAC) control element (CE) associated with the PUCCH resource, and the MAC CE indicates an identity of a serving cell for which the MAC CE is applied and an identity of a bandwidth part (BWP) for which the MAC CE is applied.

12. The BS of claim 11, wherein the MAC CE indicates an identity of the PUCCH resource or an identity of another PUCCH resource in a PUCCH resource group at least comprising the PUCCH resource, and for the PUCCH resource group, the MAC CE comprises an identity of only one PUCCH resource of the PUCCH resource group.

13. (canceled)

14. The BS of claim 8, wherein the plurality of beams is a first beam and a second beam, and the beam indication indicates at least one of the first beam or the second beam for the PUCCH resource.

15. (canceled)

16. A user equipment (UE) for wireless communication, comprising:
at least one memory; and
at least one processor coupled with the at least one memory and configured to cause the UE to:
receive information for determining a plurality of beams;
receive a beam indication indicating at least one beam of the plurality of beams to be used for transmission of a physical uplink control channel (PUCCH) resource; and
transmit the PUCCH resource according to the beam indication.

17. The UE of claim 16, wherein the beam indication is received in configuration information of the PUCCH resource.

18. The UE of claim 16, wherein the beam indication is received in configuration information of a PUCCH resource group at least comprising the PUCCH resource.

19. The UE of claim 16, wherein the beam indication is received in a medium access control (MAC) control element (CE) associated with the PUCCH resource, and the MAC CE indicates an identity of a serving cell for which the MAC CE is applied and an identity of a bandwidth part (BWP) for which the MAC CE is applied.

20. The UE of claim 19, wherein the MAC CE indicates an identity of the PUCCH resource or an identity of another PUCCH resource in a PUCCH resource group at least comprising the PUCCH resource.

21. The UE of claim 20, wherein for the PUCCH resource group, the MAC CE comprises an identity of only one PUCCH resource of the PUCCH resource group.

22. The UE of claim 16, wherein the plurality of beams is a first beam and a second beam, and the beam indication indicates at least one of the first beam or the second beam for the PUCCH resource.

23. A processor for wireless communication, comprising:
at least one controller coupled with at least one memory and configured to cause the processor to:
receive information for determining a plurality of beams;
receive a beam indication indicating at least one beam of the plurality of beams to be used for transmission of a physical uplink control channel (PUCCH) resource; and
transmit the PUCCH resource according to the beam indication.
